(19) United States
(12) Patent Application Publication
(10) Pub. No.: US 2004/0150809 A1
(43) Pub. Date: Aug. 5, 2004

(54) [MASK FOR FABRICATING A CONTACT AND CONTACT PROCESS THEREOF]

(76) Inventors: Chih-Chin Chang, Hsinchu (TW); Shih-Yi Yen, Kaohsiung (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/605,055

(22) Filed: Sep. 5, 2003

(30) Foreign Application Priority Data
Jan. 30, 2003 (TW) 92102150

(51) Int. Cl. G03B 27/32

(52) U.S. Cl. 355/77

(57) ABSTRACT

A mask for fabricating contacts is provided. The mask has a contact pattern with an edge pattern around the edge of the contact pattern. The edge pattern is a half-tone region. Due to the half-tone edge pattern on the mask, contact angle between the sidewall of the contact opening and an underlying conductive layer after a patterning process is reduced.

### CROSS REFERENCE TO RELATED APPLICATIONS

This application claims the priority benefit of Taiwan application serial no. 92102150, filed Jan. 30, 2003.

### BACKGROUND OF INVENTION

1. Field of Invention

The present invention relates to a mask and its application. More particularly, the present invention relates to a mask for fabricating a contact and the contact process thereof.

2. Description of Related Art

In the fabrication of a liquid crystal display, non-photosensitive dielectric material or organic photosensitive material is often used to form the insulating layer of a thin film transistor array. To ensure the conductive layers above and below the insulating layer are electrically connected, a patterning process (for example, photolithographic and etching processes or photolithographic process alon) is carried out to form a contact. For example, the pixel electrode and the drain terminal of a thin film transistor in a pixel structure must be electrically connected. To form the necessary electrical connection, a patterning process is carried out to form a contact opening that exposes the drain terminal in the insulating layer before forming a pixel electrode over the insulating layer.

In general, a liquid crystal display that needs to form lots of openings chooses organic photosensitive material (for example, a photoresist material) over other substances for fabricating the insulating layer. However, organic photosensitive material generally has a thick coverage and hence produces a contact opening with steep sides. In other words, the sidewall of a contact opening often forms an angle approaching 70° with a conductive layer under the contact as shown in FIG. 1A.

FIGS. 1A and 1B are schematic cross-sectional views showing the steps for fabricating a conventional contact. As shown in FIG. 1A, an organic photosensitive layer 104 is formed over a conductive layer 102 above a substrate 100. The organic photosensitive layer 104 has a contact opening 106. In the fabrication of a liquid crystal display, the conductive layer 102 is the drain terminal of a thin film transistor and the contact opening 106 is a region for connecting the pixel electrode with the drain terminal, for example. However, due to the thickness of the organic photosensitive layer 104, sidewalls of the patterned contact opening 106 are rather steep. In other words, the sidewall of the contact opening 106 and the underlying conductive layer 104 forms a contact angle 108 of almost 70°.

Because the contact opening 106 has steep sidewalls, step coverage of a pixel electrode 110 formed over the organic photosensitive layer 104 and the contact opening by sputtering is poor. As shown in FIG. 1B, the pixel electrode 110 may break easily.

### SUMMARY OF INVENTION

Accordingly, one object of the present invention is to provide a mask for fabricating a contact and a contact process thereof. By reducing the contact angle between the sidewalls of a contact and an underlying layer, breakage of a subsequently formed conductive layer inside the contact opening is prevented.

A second object of this invention is to provide a mask for fabricating a contact and a contact process thereof that produces a better contact without changing any fabrication steps. Only the design of the mask needs to be changed.

To achieve these and other advantages and in accordance with the purpose of the invention, as embodied and broadly described herein, the invention provides a mask for fabricating a contact process. The mask has a contact pattern thereon. The edge of the contact pattern includes a special edge pattern. The edge pattern is a half-tone exposure region. The contact pattern can have a circular, polygonal or irregular shape. The edge pattern at the edge of the contact can have several designs. According to one preferred embodiment, the edge pattern is a sawtooth pattern with sharp pointed sawtooth or truncated sawtooth lining the edge. According to another preferred embodiment, the edge pattern is a circular pattern with at least one circle. In other words, at least one circular pattern is placed outside the contact pattern. The circular pattern may be concentric with the contact pattern or non-concentric with the contact pattern or the circular pattern may spiral away from the contact pattern. According to yet another preferred embodiment, the edge pattern is a multi-sided mosaic pattern. For example, the multi-sided mosaic pattern can be a four-sided mosaic pattern.

This invention also provides a contact fabrication process. A substrate having a first conductive layer and a dielectric layer over the first conductive layer is provided. A mask is set up over the dielectric layer. The mask has a contact pattern whose edges include an edge pattern. The edge pattern is a half-tone exposure region. The contact and associated edge pattern on the mask are designed according to the aforementioned specifications. Thereafter, a patterning process is conducted to form a contact opening in the dielectric layer. The contact opening exposes the first conductive layer. If the dielectric layer is fabricated using an organic photosensitive material, the patterning process is a photolithographic process. On the other hand, if the dielectric layer is fabricated using a non-photosensitive material, a photoresist layer must form over the dielectric layer before conducting a photolithographic and an etching process to form the contact opening. The sidewall of the contact opening and the underlying conductive layer form a contact angle smaller than 70°.

In this invention, the edges of contact pattern on the mask are half-tone exposure region. Hence, after transferring the contact pattern on the mask onto the dielectric layer, sidewalls of the contact opening have a rather gentle slope. In other words, the contact angle between the sidewall of the contact opening and the conductive layer under the contact is reduced.

Due to a reduction in the contact angle between the sidewall of the contact opening and the underlying conductive layer, subsequently deposited conductive material over the dielectric layer and the contact opening has a good step coverage. Hence, the probability of having a broken contact is greatly reduced.

In brief, this invention utilizes special pattern design on a contact mask to improve contact quality. Furthermore, no additional steps are needed in the contact process because no changes other than the mask pattern are demanded.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A and 1B are schematic cross-sectional views showing the steps for fabricating a conventional contact.

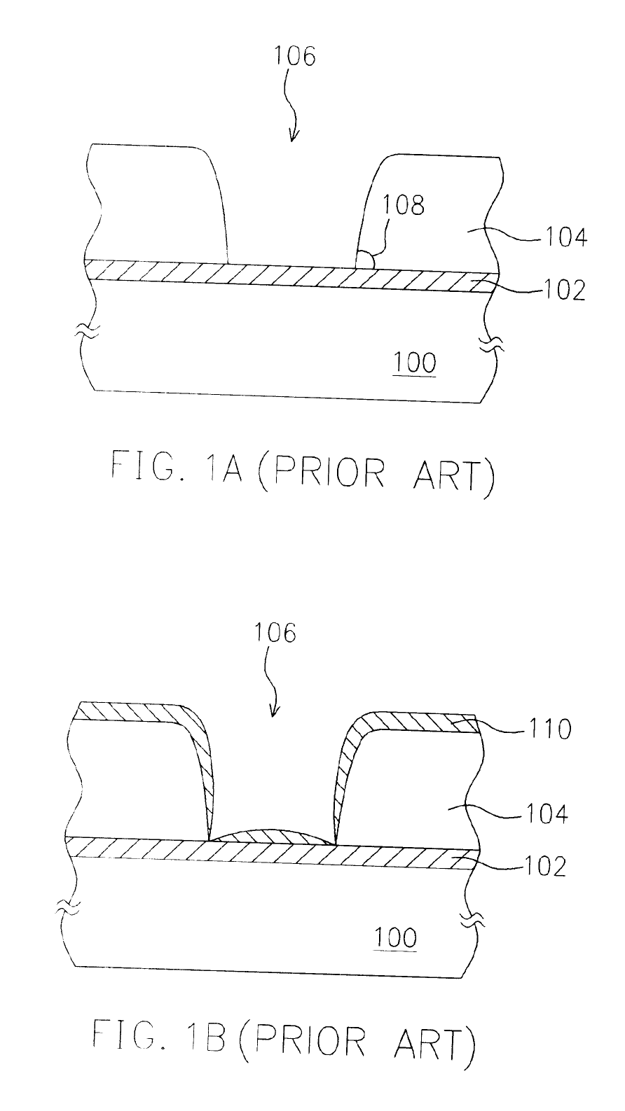

FIGS. 2A to 2E are schematic cross-sectional views showing the steps for fabricating a contact according to one preferred embodiment of this invention.

FIG. 3 is a top view of a contact mask according to a first preferred embodiment of this invention.

FIG. 4 is a top view of an alternative contact mask according to the first preferred embodiment of this invention.

FIG. 5 is a top view of a contact mask according to a second preferred embodiment of this invention.

FIG. 6 is a top view of another contact mask according to the second preferred embodiment of this invention.

FIG. 7 is a top view of yet another contact mask according to the second preferred embodiment of this invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

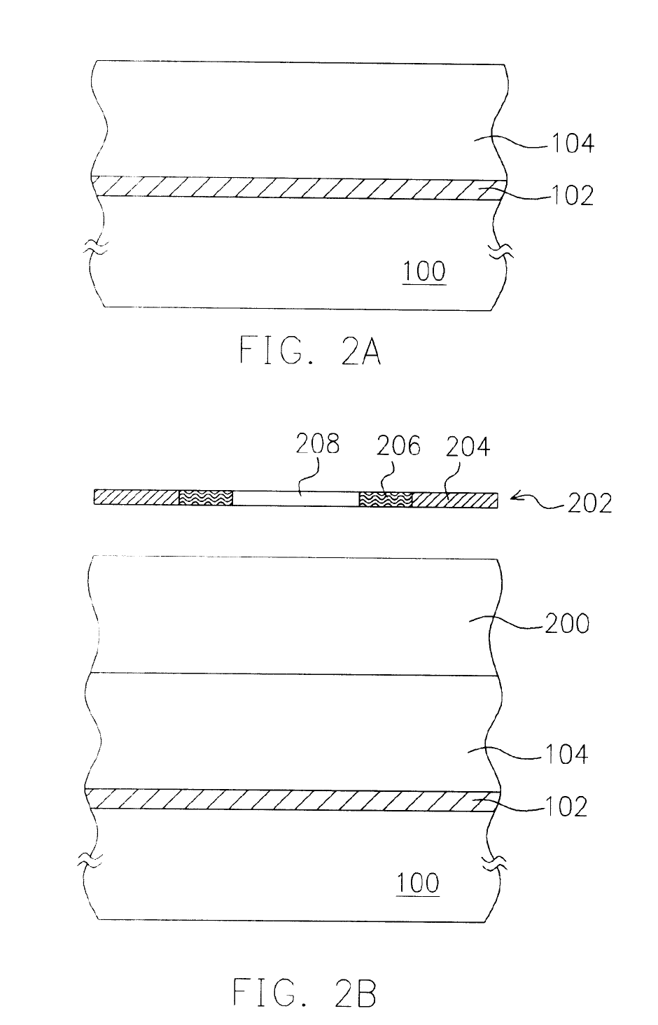

FIGS. 2A to 2E are schematic cross-sectional views showing the steps for fabricating a contact according to one preferred embodiment of this invention. As shown in FIG. 2A, a substrate 100 having a conductive layer 102 and a dielectric layer 104 over the conductive layer 102 is provided. If the contact process is applied to fabricate a liquid crystal display, the conductive layer 102 can be the second metallic layer (M2) in the thin film transistor, that is, the drain terminal of the thin film transistor or the upper electrode of the pixel storage capacitor. The dielectric layer 104 is fabricated using a non-photosensitive inorganic material including, for example, silicon nitride or silicon oxide. However, in the fabrication of liquid crystal display with lots of openings, the dielectric layer 104 is normally fabricated using an organic photosensitive material (for example, photoresist material).

As shown in FIG. 2B, assume that the dielectric layer 104 is fabricated from a non-photosensitive inorganic dielectric material, a photoresist layer 200 is formed over the dielectric layer 104 and then a mask 202 is set up over the photoresist layer 200. The mask 202 has an exposure region 208, a half-tone region 206 and a non-exposure region 204. Here, the exposure region 208 is a place where the contact pattern is located and the half-tone region 206 is located at the edge of the contact pattern 208. The non-exposure region 204 occupies the remaining area of the mask 202. In this invention, the half-tone region is an area with a specially designed edge pattern for producing half-tone exposure effects.

On the other hand, if the dielectric layer 104 is an organic photosensitive material layer, there is no need to form a photoresist layer 200 over the dielectric layer 104 before setting the mask 202 over the dielectric layer 104.

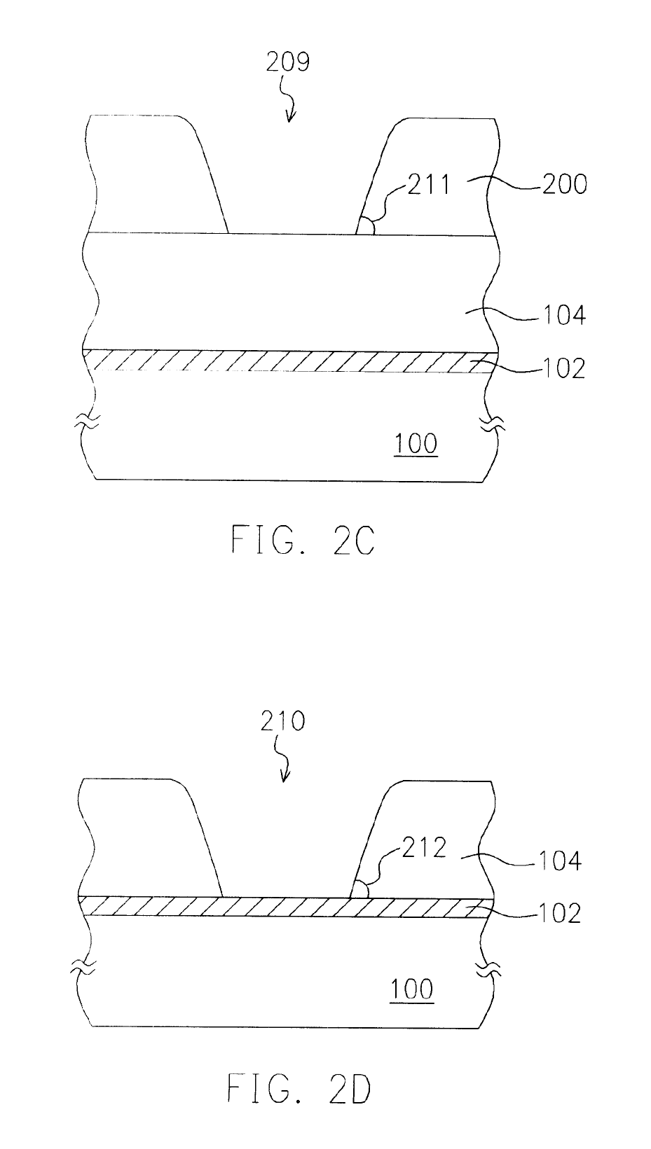

A few actual contact mask designs are shown in FIGS. 3 to 7. Since the contact mask can be designed in a variety of ways and in different combinations, the designs in FIGS. 3 to 7 serve an illustration only and should by no means limit the scope of this invention.

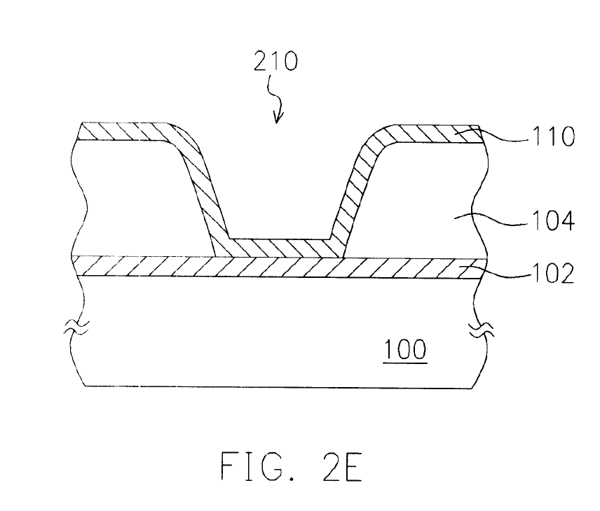

As shown in FIGS. 3 and 4, the contact mask 202 has a contact pattern 208 thereon. The contact pattern 208 is an exposure region. The contact pattern 208 can have a circular, a polygonal or an irregular shape. In the figures, a circular contact pattern 208 is shown. To provide half-tone effect at the edge of the contact pattern 208, the edge of the contact pattern 208 is designed to include a series of sawtooth. The sawtooth lining the edge can be sharp pointed sawtooth 206a (as shown in FIG. 3), truncated sawtooth 206b (as shown in FIG. 4) or some other sawtooth-like profiles.

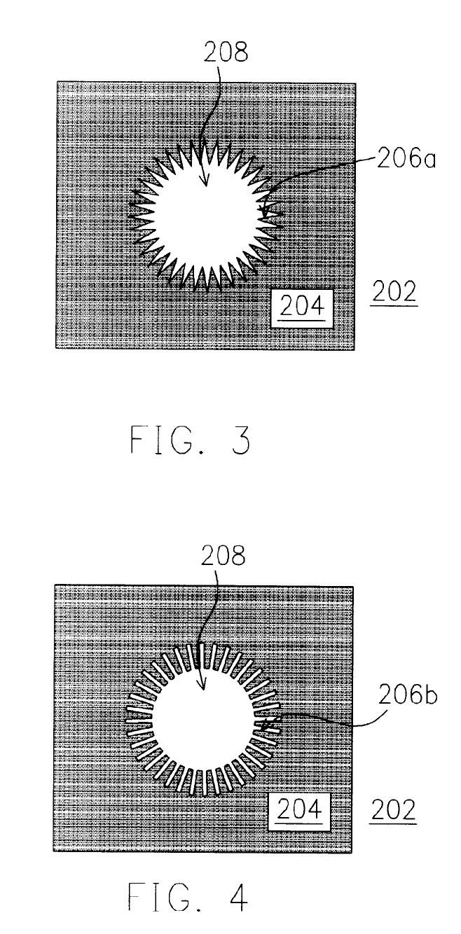

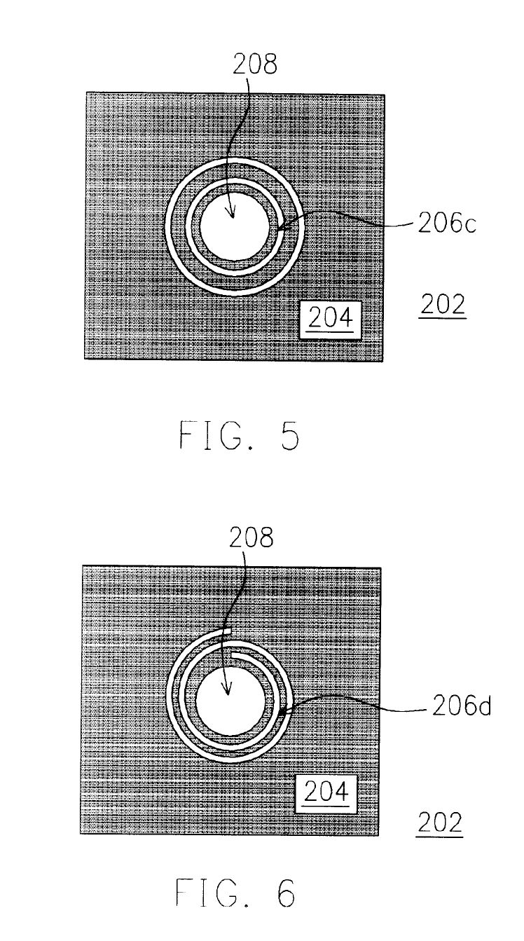

FIGS. 5 and 6 illustrate another contact mask design. As shown in FIGS. 5 and 6, the contact mask 202 also has a contact pattern 208 thereon. The contact pattern 208 is an exposure region. The contact pattern 208 can have a circular, a polygonal or an irregular shape. Similarly, a circular contact pattern 208 is shown. To provide half-tone effect at the edge of the contact pattern 208, the edge of the contact pattern 208 is designed to include at least a circular pattern. The circular pattern can be a circular concentric pattern 206c (as shown in FIG. 5), a spiral pattern 206d (as shown in FIG. 6) or some other concentric patterns.

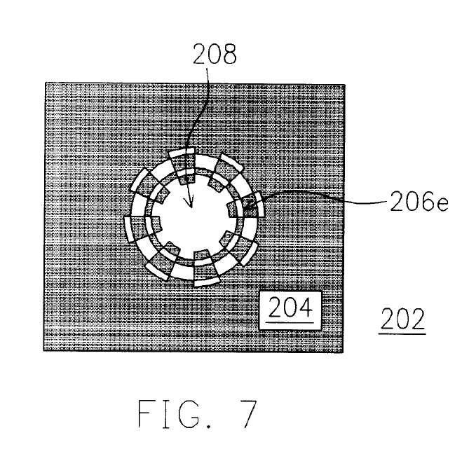

FIG. 7 illustrates yet another contact mask design. As shown in FIG. 7, the contact mask 202 also has a contact pattern 208 thereon. The contact pattern 208 is an exposure region. The contact pattern 208 can have a circular, a polygonal or an irregular shape. Similarly, a circular contact pattern 208 is shown. To provide half-tone effect at the edge of the contact pattern 208, the edge of the contact pattern 208 is designed to have a polygonal mosaic edge pattern. For example, the edge can have a four-sided mosaic edge pattern 206e (as shown in FIG. 7) or some other mosaic edge patterns.

In all of the aforementioned masks, the edge of each contact pattern is specially designed to produce some half-tone effect after a photo-exposure operation. A variety of edge patterns can be used including, for example, sawtooth lining, circular ring, polygonal mosaic and many others.

Next, as shown in FIG. 2A, the mask 202 is placed over the photoresist layer 200 and a photo-exposure is conducted. The exposed photoresist layer 200 is developed to form a patterned photoresist layer 200 with an opening 209 that exposed the dielectric layer 104 as shown in FIG. 2C.

Because the edge of the contact pattern 208 on the mask 202 includes a specially designed pattern 206 (for example, the pattern as shown in FIGS. 3 to 7), some half-tone effect will result due to a combination of resolution and optical proximity effect after the photo-exposure process. Therefore, the opening 209 in the photoresist layer 200 has a rather gentle slope after chemical development. In other words, the sidewalls of the opening 209 and the underlying dielectric layer 104 form a contact angle 211 smaller than 70°.

Thereafter, using the photoresist layer 200 as an etching mask, the dielectric layer 104 is etched to form a contact opening 210 that exposes the conductive layer 102. The photoresist layer 200 is then removed to form a structure shown in FIG. 2D. The contact opening 210 also has sidewalls with gentle slope. In other words, the sidewalls of the contact opening 210 and the underlying conductive layer 102 also form a contact angle 212 smaller than 70°.

Note that if the dielectric layer 104 is fabricated using an organic photosensitive material, photo-exposure and chemical development can be carried out immediately after setting the mask 202 over the dielectric layer 104 to form a contact opening 210 that exposes the conductive layer 102 in the dielectric layer 104. Similarly, the contact opening 210 also has sidewalls with gentle slope. In other words, the sidewalls of the contact opening 210 and the underlying conductive layer 102 also form a contact angle 212 smaller than 70°.

As shown in FIG. 2E, a conductive layer 110 is formed over the dielectric layer 104 and the interior surface of the opening 210. The conductive layer 110 and the conductive layer 102 are electrically connected through the contact opening 210. In the fabrication of a liquid crystal display, the conductive layer is a transparent pixel electrode fabricated using a material including, for example, indium-tin oxide.

In this invention, the edges of the contact pattern on the mask are fabricated into a half-tone exposure region. Hence, after transferring the contact pattern on the mask onto the dielectric layer, sidewalls of the contact opening have a rather gentle slope. In other words, the contact angle between the sidewall of the contact opening and the conductive layer under the contact is reduced.

In addition, due to a reduction in the contact angle between the sidewall of the contact opening and the underlying conductive layer, subsequently deposited conductive material over the dielectric layer and the contact opening has a good step coverage. Hence, the probability of having a broken contact is greatly reduced.

Furthermore, the utilization of special pattern designs on a contact mask to improve contact quality requires no additional steps in the contact process.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A mask for fabricating contacts, comprising:
a contact pattern having a photo-exposure region; and
an edge pattern at the edge of the contact pattern, wherein the edge pattern is a half-tone region.

2. The mask of claim 1, wherein the edge pattern includes a sawtooth edge pattern.

3. The mask of claim 2, wherein the sawtooth edge pattern includes an edge lining with a series of sharp point sawtooth.

4. The mask of claim 2, wherein the sawtooth edge pattern includes a band with a series of truncated sawtooth.

5. The mask of claim 1, wherein the edge pattern includes at least a circular pattern.

6. The mask of claim 5, wherein the circular pattern includes at least a concentric circular pattern.

7. The mask of claim 5, wherein the circular pattern includes at least a non-concentric circular pattern.

8. The mask of claim 5, wherein the circular pattern includes at least a spiral pattern.

9. The mask of claim 1, wherein the edge pattern includes a polygonal mosaic edge pattern.

10. The mask of claim 9, wherein the polygonal mosaic edge pattern includes a four-sided mosaic edge pattern.

11. A method of forming contacts, comprising the steps of:
providing a substrate having a first conductive layer and a dielectric layer over the first conductive layer;
setting up a mask over the dielectric layer, wherein the mask further includes:
a contact pattern having a photo-exposure region; and
an edge pattern at the edge of the contact pattern, wherein the edge pattern is a half-tone region;
conducting a patterning process to form a contact opening in the dielectric layer, wherein the contact opening exposes the first conductive layer; and
forming a second conductive layer over the exposed surface of the contact opening.

12. The contact process of claim 11, wherein the sidewall of the contact opening and the first conductive layer form a contact angle smaller than 70°.

13. The contact process of claim 11, wherein the pattern process is a photolithographic process if the dielectric layer is fabricated from organic photosensitive material.

14. The contact process of claim 11, wherein the steps of setting up a mask over the dielectric layer and conducting a patterning process is replaced by the following sub-steps if the dielectric layer is fabricated from a non-photosensitive material:
forming a photoresist layer over the dielectric layer;
setting up a mask over the photoresist layer;
conducting a photolithographic and etching process in sequence to form a contact opening in the dielectric layer; and
removing the photoresist layer.

15. The contact process of claim 11, wherein the edge pattern on the mask includes a sawtooth edge pattern.

16. The contact process of claim 11, wherein the edge pattern on the mask includes at least a circular pattern.

17. The contact process of claim 11, wherein the edge pattern on the mask includes at least a polygonal mosaic edge pattern.
